(19) United States
(12) Patent Application Publication
(10) Pub. No.: US 2020/0327541 A1
(43) Pub. Date: Oct. 15, 2020

(54) DATA PROCESSING METHOD OF A DUAL-TRACK TOKEN SYSTEM FOR EXCHANGE OF ONLINE SERVICES

(71) Applicant: Chen-Hsuan Huang, Taipei City (TW)

(72) Inventor: Chen-Hsuan Huang, Taipei City (TW)

(21) Appl. No.: 16/694,884

(22) Filed: Nov. 25, 2019

(30) Foreign Application Priority Data
Apr. 10, 2019 (TW) 108112574

(51) Int. Cl. G06Q 20/38; G06Q 20/36; H04L 29/06; G06Q 20/12; G06Q 20/40

(52) U.S. Cl. CPC G06Q 20/385; G06Q 20/367; G06Q 20/401; G06Q 20/12; H04L 63/08

(57) ABSTRACT

A data processing method of a dual-track token system for exchange of online services classifies services into category A services, which can be paid by class A and/or B tokens, and category B services, which are restricted to be paid by class B tokens, thereby allowing selection on objects to be served. Once a service provider and a service demander are matched, the service demander pays the service using class A tokens or class B tokens. The service demander may evaluate the service provided. The online network trading platform determined class A tokens, class B tokens and/or class B credits to be acquired by the service provider. Class A tokens are purchasable by fiat currency, transferable to another person, and/or convertible to fiat currency. Class B tokens is convertible into class A tokens but neither transferable nor purchasable. Class B tokens is obtained only by providing satisfactory services.

### CROSS-REFERENCE TO RELATED APPLICATION

This application claims the priority of Taiwanese patent application No. 108112574, filed on Apr. 10, 2019, which is incorporated herewith by reference.

### BACKGROUND OF THE INVENTION

### 1. Field of the Invention

The present invention relates generally to a data processing method, and more particularly, to a data processing method of a dual-track token system for exchange of online services.

### 2. The Prior Arts

Conventional service exchange systems utilize fiat currency for service exchange, in which source of fiat currency cannot be tracked. That is, the compensation obtained through exchange of any forms of labor services can be used to consume another service; a service provider is unable to determine the source of fiat currency used by the objects he or she served. Yet in some situations, service providers intend to select objects to be served, desiring to make transactions only with those having particular values or experiences.

Currently, the quality of online services does not affect prices, so service providers are not motivated to provide services with better quality and some good service providers are not correspondingly rewarded.

Conventional online service trading platforms commonly lack a method to identify users by a true resume generated by the user's interaction with the real society, but merely identify users by the information provided by them.

Thus, it has become a technical problem for persons in the art to determine a method which allows a user of an online service trading platform to effectively identify others and select the objects to be served.

### SUMMARY OF THE INVENTION

In order to solve the problem mentioned, an objective of the present invention is to provide a data processing method of a dual-track token system for exchange of online services.

The method is applied to an online network trading platform constructed under a centralized or a distributed data network structure, and the method comprises steps: (a) the online network trading platform classifying services into at least one category A service and at least one category B service; wherein if a service provider does not select a service demander to be served, proceed to step (b); (b) the service provider publishing a type of service to be provided as a subordinate of category A services and setting a service price for the type of service to be provided via a first terminal device; wherein the service price is shown on the online network trading platform; (c) the service demander demanding and purchasing the service by filing a transaction request via a second terminal device; wherein once the online network trading platform successfully matches the service provider with the service demander, the service demander pays for the service price using class A tokens via the second terminal device; and wherein class A tokens are obtained through exchange from fiat currency or valuables on the online network trading platform via the second terminal device; (d) after completion of the transaction, the service demander evaluating the type of service provided by the service provider with a score via the second terminal device; wherein the online network trading platform performs calculations and depends thereon to determine X number of class A tokens, Y number of class B tokens subordinated to the type of service provided and/or Y points of class B credits subordinated to the type of service provided to be acquired by the service provider; wherein a sum of X number of class A tokens and Y number of class B tokens subordinated to the type of service provided is equivalent to the service price; wherein the higher the score the higher the ratio of class B tokens subordinated to the type of service provided to the service price; and wherein class B credits subordinated to the type of service provided become a part of service resume of the service provider whilst class B tokens subordinated to the type of service provided are permitted for purchasing at least one category B service; and (e) the service provider selectively converting class B tokens subordinated to the type of service into class A tokens and/or consuming at least one category A service on the online network trading platform via the first terminal device; alternatively, the service provider selectively exchanging class A tokens for fiat currency or valuables on the online network trading platform via the first terminal device.

Another objective of the present invention is to provide another data processing method of dual-track token system for exchange of online services.

The method is applied to an online network trading platform constructed under a centralized or a distributed data network structure, and the method comprises steps: (a) the online network trading platform classifying services into at least one category A service and at least one category B service; wherein if the service provider does select the service demander to be served, proceed to steps: (b′) the service provider publishing a type of service to be provided as a subordinate of category B services and setting a service price to be paid by at least one type of class B tokens for the type of service to be provided via a first terminal device; wherein the service price in the type of class B tokens required is shown on the online network trading platform; (c′) the service demander demanding the service and purchasing the service by filing a transaction request via a second terminal device; wherein the online network trading platform examines the transaction request and permits a transaction requester who is capable to pay the service price in the type of class B tokens required by the service provider to be matched; as the online network trading platform successfully matches the service provider and the service demander, the service demander pays for the service price using the required type of class B tokens via the second terminal device; and wherein the required type of class B tokens are obtained by the service demander through the service demander's prior service provisions on the online network trading platform; (d′) after completion of the transaction, the service provider obtaining at least one type of class A tokens depending on the service price from the online network trading platform via the first terminal device; and (e′) the service provider consuming at least one category A service using the type of class A tokens on the online network trading platform via the first terminal device; alternatively, the service provider selectively exchanging the type of class A tokens for fiat currency or valuables on the online network trading platform via the first terminal device.

### BRIEF DESCRIPTION OF THE DRAWINGS

The present invention will be apparent to those skilled in the art by reading the following detailed description of a preferred embodiment thereof, with reference to the attached drawings, in which:

FIGS. 1A and 1B are flow charts illustrating a data processing method of a dual-track token system for exchange of online services according to a first embodiment of a first aspect of the present invention;

FIGS. 2A and 2B are flow charts illustrating a data processing method of a dual-track token system for exchange of online services according to a second embodiment of the first aspect of the present invention;

FIGS. 3A and 3B are flow charts illustrating a data processing method of a dual-track token system for exchange of online services according to a third embodiment of the first aspect of the present invention;

FIGS. 4A and 4B are flow charts illustrating a data processing method of a dual-track token system for exchange of online services according to a first embodiment of a second aspect of the present invention;

FIGS. 5A and 5B are flow charts illustrating a data processing method of a dual-track token system for exchange of online services according to a second embodiment of the second aspect of the present invention.

### DETAILED DESCRIPTION OF THE PREFERRED EMBODIMENT

The present invention will be hereafter illustrated by the following embodiments. It will be apparent that the embodiments referred do not intend to restrict the present invention within any specific environments, applications, or exclusive executions. The embodiments are provided for the purpose of explanation, but not limitation. It should be noted that, for easy comprehension, elements which are not directly related to the present invention might have been omitted and not shown in the embodiments and the attached figures, and elements might not be shown in their actual scale with respect to each other.

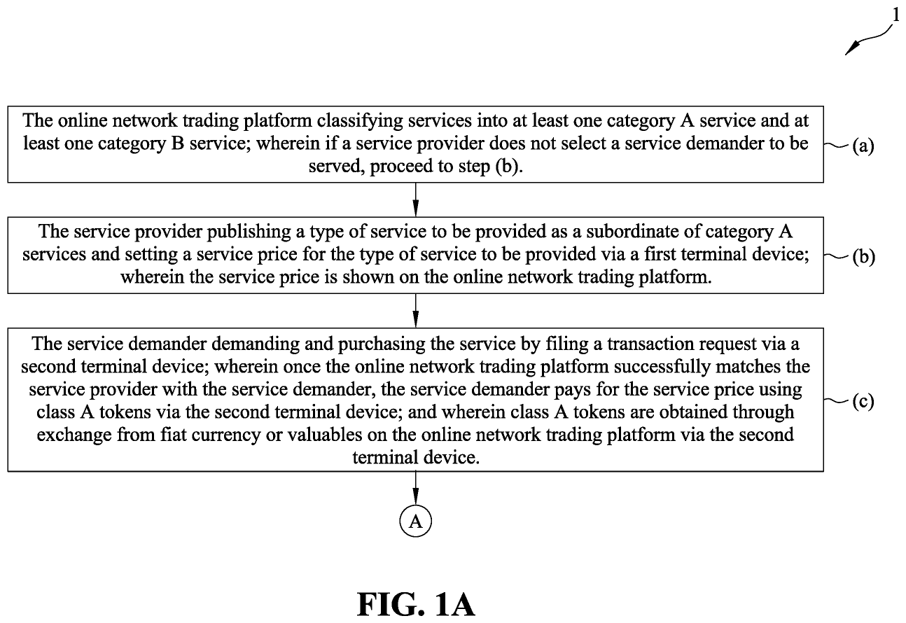

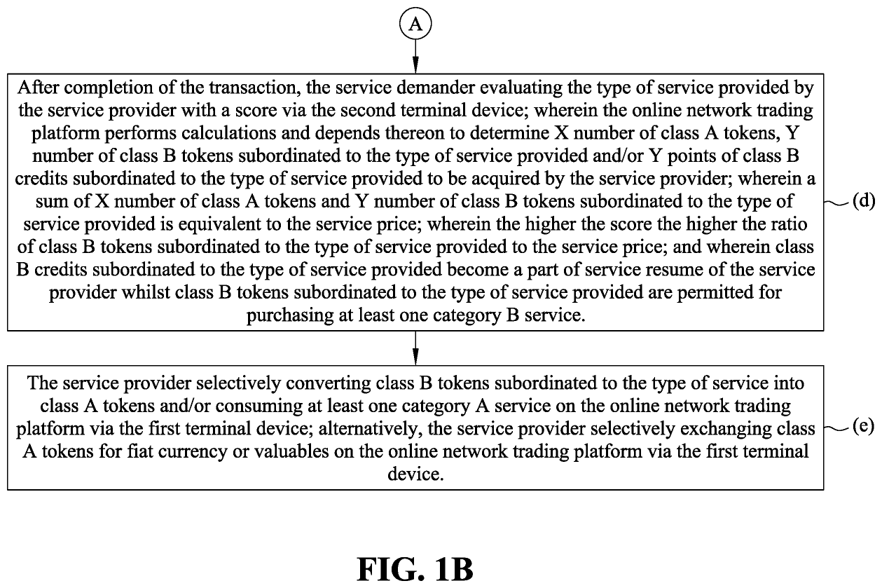

FIGS. 1A and 1B are flow charts illustrating a data processing method of a dual-track token system for exchange of online services according to a first embodiment of a first aspect of the present invention. The method in the first aspect will be referred as method 1 hereafter.

The method 1 may be applied to an online network trading platform. The online network trading platform includes but not limited to online dating platforms, online consulting platforms, online contracting platforms, online job hunting platforms, online shopping platforms, online socializing platforms, other services exchange platforms and/or internet membership systems with specific orientation or targets.

It is noted that, the term “service(s)” used in the present invention refers to service(s) and/or product(s); that is, either services that bear no actual shape and/or products which bear an existing shape are intended to be included in the scope of the claims of the present invention. However, the present invention abbreviated them as “service(s)” in the claims.

The method 1 may be constructed under a centralized data network structure or a distributed data network structure. Centralized data network structure refers to a concept with a central server, in which data is stored in a single database and operating system is centralized and deployed on a single server. Distributed data network structure is a concept of data decentralization, in which hardware or software components are distributed on different network computers to communicate and coordinate with each other through transmittance of messages. For example, cloud servers which are now commonly used are an aspect of centralized data network, and block chains are an aspect of distributed data network structure. The method 1 of the present invention is applicable for either a centralized data network structure or a distributed data network structure.

The method 1 comprises steps (a), (b), (c), (d) and (e).

(a) The online network trading platform classifies services into at least one category A service and at least one category B service. If a service provider does not select a service demander to be served, proceed to step (b).

More specifically, if illustrating category A services and category B services by labor services, category A services may be categorized into several types such as athletic services, music services, environment protecting services etc. Athletic services for example may be coaching basketball, music services for example may be teaching singing, and environment protecting services may be instructing plantation of flowers or trees. Category B services are similar to category A services. Both category A services and category B services may include various types of services or products.

It is noted that, if the service provider does not intend to select an object to be served, i.e. service demander, refer to the flowing charts of the method 1 for proceeding steps.

(b) The service provider publishes a type of service to be provided as a subordinate of category A services and sets a service price for the type of service to be provided via a first terminal device; wherein the service price is shown on the online network trading platform.

In step (b), the service provider publishes the service he prefers to provide and sets the service price by his own; that is, if the service provider publishes a service, for example, coaching basketball, as a subordinate of category A services, and sets the service price for basketball coaching via the first terminal device, the service price will be shown on the online network trading platform such that people who demand such service may be accessible to the service.

(c) The service demander demands the service and purchases the service by filing a transaction request via a second terminal device, wherein once the online network trading platform successfully matches the service provider with the service demander, the service demander pays for the service price using class A tokens via the second terminal device. Class A tokens are obtained through exchange from fiat currency or valuables on the online network trading platform via the second terminal device.

In step (c), if the service demander needs the basketball coaching service, the service demander may file the transaction request for purchase to the online network trading platform via the second terminal device (the service demander's own terminal device). Once the online network trading platform successfully matches the service provider with the service demander, the service demander will be requested to pay for the service price via the second terminal device. It is noted that, the payment in the present invention is executed by means of tokens, not by direct usage of fiat currency (including but not limited to New Taiwanese Dollars). The tokens may be obtained through conversion from fiat currency or valuables on the online network trading platform.

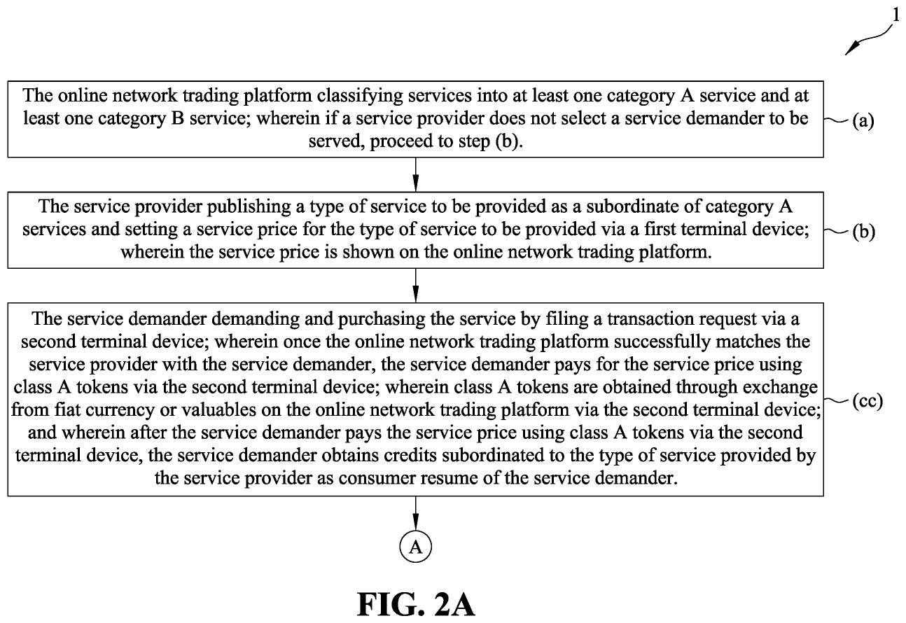

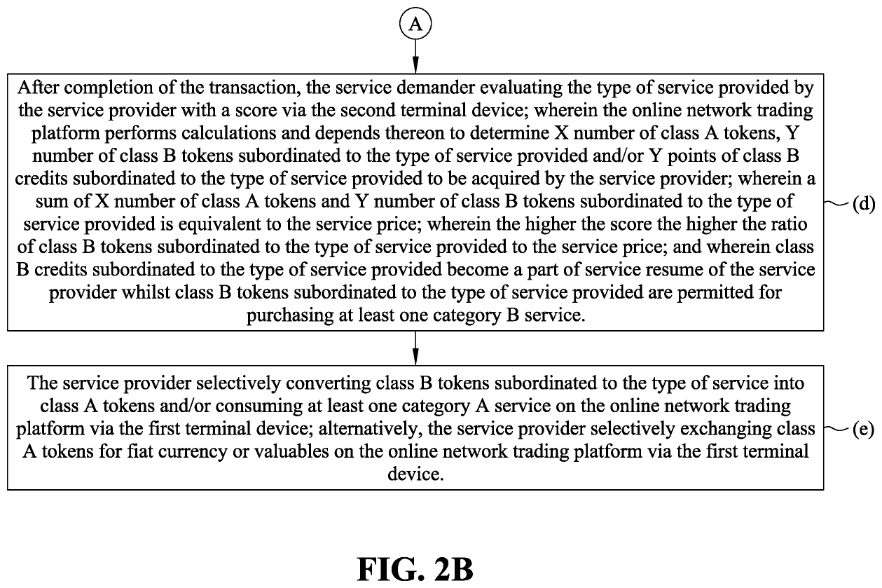

Referring to FIGS. 2A and 2B, which illustrates a second embodiment of the method 1. FIGS. 2A and 2B are similar to FIGS. 1A and 1B, other than that step (c) in FIG. 1A is substituted by step (cc) of FIG. 2A. Step (cc) of the present embodiment is based on step (c); however, in step (cc), after the service demander pays for the service price using class A tokens via the second terminal device (i.e. the service demander's own terminal device), the service demander may obtain credits subordinated to the type of service provided by the service provider, as the service demander's consumer resume. That is, past consumption tendency and consumption history are revealed by means of the credits the service demander obtains. The credits reveal the service demander's consumption habits, and from which others may get to know about him.

(d) After completion of the transaction, the service demander evaluates the type of service provided by the service provider with a score via the second terminal device; wherein the online network trading platform performs calculations and depends thereon to determine X number of class A tokens, Y number of class B tokens subordinated to the type of service provided and/or Y points of class B credits subordinated to the type of service provided to be acquired by the service provider. A sum of X number of class A tokens and Y number of class B tokens subordinated to the type of service provided is equivalent to the service price. The higher the score the higher the ratio of class B tokens subordinated to the type of service provided to the service price. Class B credits subordinated to the type of service provided become a part of service resume of the service provider whilst class B tokens subordinated to the type of service provided are permitted to purchase at least one category B service.

In step (d), after completion of the transaction, as for the example of basketball coaching, the service demander may evaluate the basketball coaching service provided by the service provider with a score when the service is completed, and the score will affect the types and ratios of tokens to be earned by the service provider. For example, if the service price of basketball coaching is 1000 dollars and the service demander feels well served and submits a score of 8 out of 10 as evaluation, the service provider will receive 800 dollars of class B tokens subordinated to the athletic service and 200 dollars of class A tokens.

The sum of the 200 dollars of class A tokens and 800 dollars of class B tokens subordinated to the athletic service is equivalent to the service price, 1000 dollars. The higher the score of evaluation the higher the ratio of class B tokens subordinated to the type of service to the service price. In the mentioned basketball coaching example, the score obtained is 8, and thus the service provider receives 800 dollars of class B tokens subordinated to the athletic service. In a similar way, if the score is 9, then the service provider receives 900 dollars of class B tokens subordinated to the athletic service. That is, the higher the score of evaluation, the service provider obtains a higher ratio of class B tokens subordinated to the athletic service out of the full service price.

Furthermore, the service provider obtains class B credits subordinated to the athletic service. Class B credits become a part of service resume of the service provider and the service provider may use class B tokens subordinated to the athletic service to purchase at least one category B service.

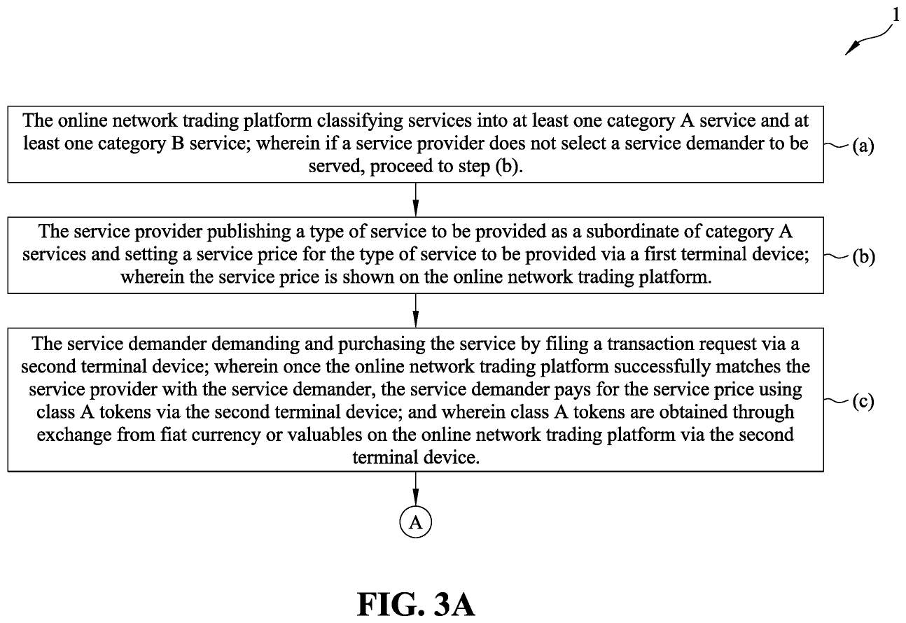

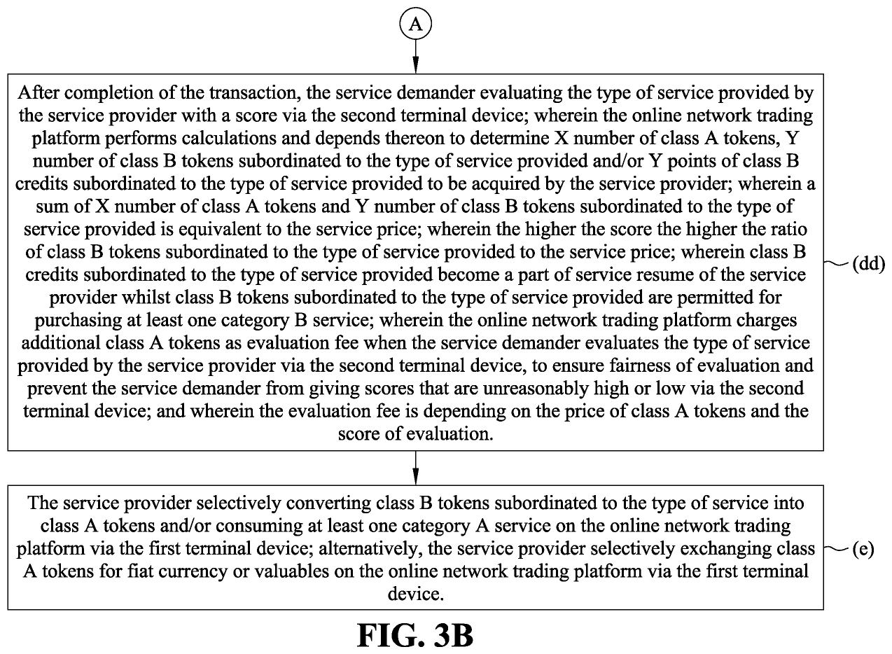

Referring to FIGS. 3A and 3B, which illustrates a third embodiment of the method 1. FIGS. 3A and 3B are similar to FIGS. 1A and 1B, other than that step (d) in FIG. 1B is substituted by step (dd) in FIG. 3B. That is, step (dd) of the present embodiment is based on step (d); however, in step (dd), the online network trading platform charges additional class A tokens as evaluation fee when the service demander evaluates the type of service provided by the service provider via the second terminal device (i.e. the service demander's terminal device), to ensure fairness of evaluation.

More specifically, the purpose thereof is to prevent the service demander from giving scores that are unreasonably high or low via the second terminal device; wherein the evaluation fee is depending on the price of class A tokens and the score of evaluation. Continuing with the basketball coaching example mentioned above, if the service demander feels well coached and submits a score of 8 out of 10 to the service provider as evaluation, the service demander not only pays 800 dollars of class B tokens subordinated to the athletic service and 200 dollars of class A tokens, but also pays for additional 80 dollars as the evaluation fee ($1000*8%). As a result, the service provider receives 800 dollars of class B tokens subordinated to the athletic service and 800 points subordinated to the athletic service.

(e) The service provider may selectively converts class B tokens subordinated to the type of service into class A tokens and/or consuming at least one category A service on the online network trading platform via the first terminal device; alternatively, the service provider may selectively exchanges class A tokens for fiat currency or valuables on the online network trading platform via the first terminal device.

Step (e) illustrates that class B tokens and class A tokens are convertible on the online network trading platform via the first terminal device once they are obtained. The 800 dollars of class B tokens subordinated to the athletic service may be converted into class A tokens and/or consumed for at least one category A service on the online network trading platform, while the 200 dollars of class A tokens obtained may also be exchanged for fiat currency or other valuables on the online network trading platform via the first terminal device.

The first and second terminal devices mentioned includes but not limits to smart phones, tablet panels, laptops, desktop computers etc.

It is noted that, the online network trading platform issues class A tokens based on reserve. When the service provider or the service demander deposits fiat currency to the online network trading platform via the first terminal device or the second terminal device, the online network trading platform issues additional class A tokens equivalent to the deposit to the service provider or the service demander. In contrast, when the service provider or the service demander intends to exchange class A tokens for fiat currency via the first terminal device or the second terminal device, the online network trading platform destroys class A tokens equivalent to the exchange.

In addition, class B tokens are convertible into class A tokens in a 1:1 ratio, and class A tokens are convertible to fiat currency based on an exchange rate (including but not limited to a fixed exchange rate or a variable exchange rate). Fiat currency is convertible to class A tokens.

Furthermore, class A tokens are characterized with at least one of the characteristics including purchasable by fiat currency, transferable to another person, and convertible to fiat currency; yet class B tokens are non-transferable and non-purchasable, the only and unique way to obtain class B tokens is by providing satisfactory services to the type of service provided.

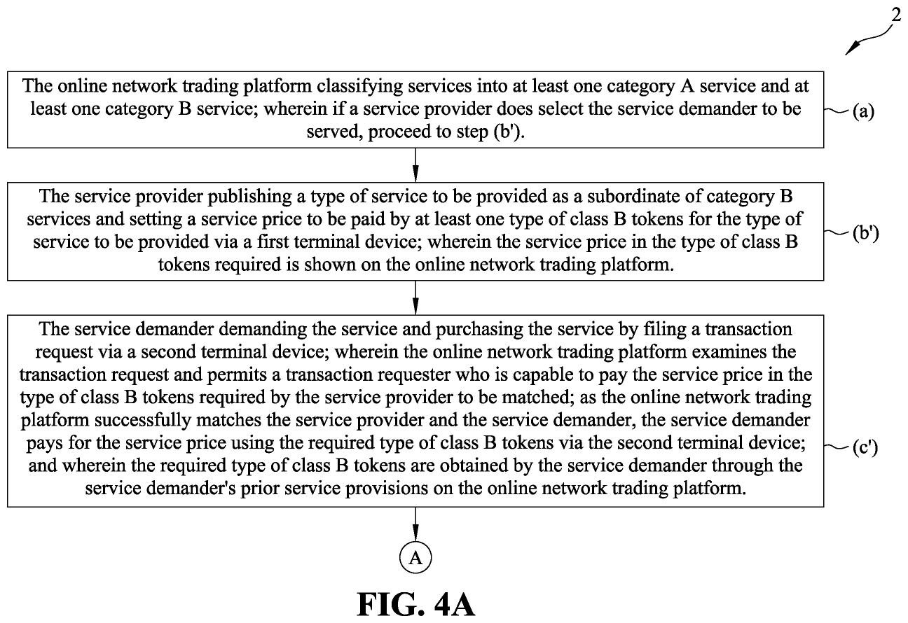

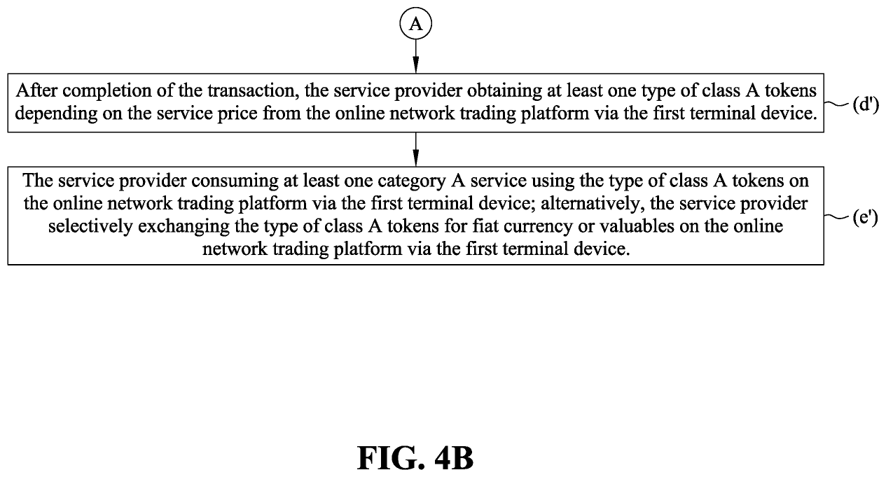

FIGS. 4A and 4B illustrates flow charts of a data processing method of a dual-track token system for exchange of online services according to a first embodiment of a second aspect of the present invention. The method in the second aspect will be referred as method 2 hereafter.

The method 2 may also be constructed under a centralized data network structure or a distributed data network structure. Centralized data network structure refers to a concept with a central server, in which data is stored in a single database and operating system is centralized and deployed on a single server. Distributed data network structure is a concept of data decentralization; in which hardware or software components are distributed on different network computers to communicate and coordinate with each other through transmittance of messages. For example, cloud servers which are now commonly used are an aspect of centralized data network, and block chains are an aspect of distributed data network structure. The method 2 of the present invention is applicable for either a centralized data network structure or a distributed data network structure.

The method 2 comprises steps (a), (b′), (c′), (d′) and (e).

(a) The online network trading platform classifies services into at least one category A service and at least one category B service. If a service provider intends to select a service demander to be served, proceed to steps (b′) to (e′).

More specifically, if illustrating category A services and category B services by labor services, category A services may be categorized into several types such as athletic services, music services, or environment protecting services etc. Athletic services for example may be coaching basketball, music services for example may be teaching singing, and environment protecting services may be instructing plantation of flowers or trees. Category B services are similar to the category A services. Both category A services and category B services may include various types of services or products.

It is noted that, if the service provider does intend to select an object to be served, i.e. service demanders, refer to the flowing charts of the method 2 for proceeding steps.

For a service provider who wants to select service demanders of particular characteristics, he may provide services which only accept class B tokens. In such case, the service demander has to pays class B tokens of arbitrary types or a specified type, but the service provider earns class A tokens as compensation when service is completed. Therefore, the service provider enjoys the selection of objects to be served but give up chances for building up his resume and reputation. In general, well-known service provider or anyone who wants to select objects to be served will provide category B services, while general public are likely to provide category A services. That is, by utilizing the mechanisms of category B services and class B tokens of the present invention, the service provider is allowed to select objects to be served.

Class B tokens are different from class A tokens in that class B tokens are not transferable and not purchasable. The only and unique way to obtain class B tokens is by providing satisfactory services to the type of service provided. Therefore, class B tokens possessed by a person reveals past high-quality services of particular types he or she had been provided, functioning as a personal resume to help elevating one's recognition and credibility on interne and help others to obtain objective information about the person. People may learn about the person by analyzing the distribution of class B tokens the person possesses.

(b′) The service provider publishes a type of service to be provided as a subordinate of category B services and setting a service price to be paid by at least one type of class B tokens for the type of service to be provided via a first terminal device; wherein the service price in the type of class B tokens required is shown on the online network trading platform.

In step (b′), the service provider publishes the service he prefers to provide and sets the service price by his own; that is, if the service provider publishes a service, for example coaching basketball, as a subordinate of category B services, and sets the service price for basketball coaching via the first terminal device, the service price will be shown on the online network trading platform such that people demanding such service can see.

(c′) The service demander demands the service and purchases the service by filing a transaction request via a second terminal device; wherein the online network trading platform examines the transaction request and permits only a transaction requestor who is capable to pay the service price in the type of class B tokens required by the service provider to be matched; as the online network trading platform successfully matches the service provider and the service demander, the service demander pays for the service price using the required type of class B tokens via the second terminal device; and wherein the required type of class B tokens are obtained by the service demander through the service demander's prior service provisions on the online network trading platform.

In step (c′), if the service demander needs the basketball coaching service, the service demander may file the transaction request for purchase on the online network trading platform via the second terminal device (i.e. the service demander's own terminal device). If the service demander fulfills the required conditions set by the service provider, that is, qualifying with the types and price of class B tokens required, the service demander passes the examination and is permitted to be matched with the service provider. Once the online network trading platform successfully matches the service provider with the service demander, the service demander will be requested to pay for the service price via the second terminal device. It is noted that, the payment in the present invention is executed by means of tokens, not by direct usage of fiat currency (including but not limited to New Taiwanese Dollars). The tokens may be obtained through exchange from fiat currency or valuables on the online network trading platform.

(d′) After completion of the transaction, the service provider obtains at least one type of class A tokens depending on the service price from the online network trading platform via the first terminal device.

It is noted that, in this case, the service provider earns class A tokens as compensation when service is completed. Therefore, the service provider enjoys the selection of objects to be served but give ups chances for building up his resume and reputation.

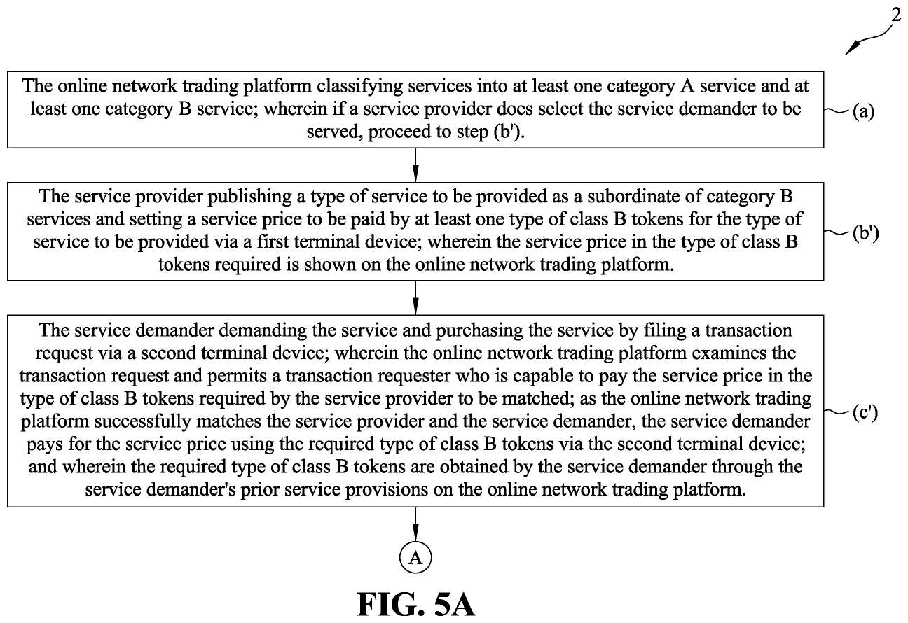

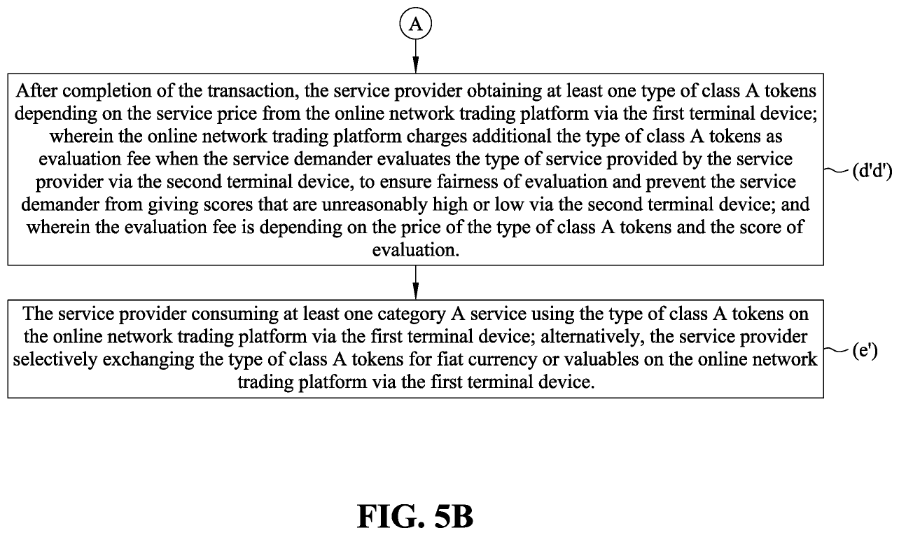

Referring to FIGS. 5A and 5B, which illustrate a second embodiment of the method 2. FIGS. 5A and 5B are similar to FIGS. 4A and 4B, other than that step (d′) in FIG. 4B is substituted by step (d′d′) of FIG. 5B. Step (d′d′) of the present embodiment is based on step (d′), but in step (d′d′), the service demander may evaluate the type of service provided by the service provider via the second terminal device (i.e. the service demander's own terminal device) depending on actual needs. The online network trading platform charges additional the type of class A tokens as evaluation fee to ensure fairness of evaluation. In particular, the purpose thereof is to prevent the service demander from giving scores that are unreasonably high or low via the second terminal device; wherein the evaluation fee is depending on the price of the type of class A tokens and the score of evaluation (details are illustrated in the preceding paragraphs).

(e′) The service provider may consume at least one category A service using the type of class A tokens on the online network trading platform via the first terminal device; alternatively, the service provider may selectively exchange the type of class A tokens for fiat currency or valuables on the online network trading platform via the first terminal device.

Step (e′) illustrates that the type of class A tokens acquired may be exchanged on the online network trading platform. The type of class A tokens acquired may be exchanged for fiat currency or valuables on the online network trading platform via the first terminal device.

The first and second terminal devices mentioned includes but not limits to smart phones, tablet panels, laptops, desktop computers etc.

It is noted that, the online network trading platform issues class A tokens based on reserve. When the service provider or the service demander deposits fiat currency to the online network trading platform via the first terminal device or the second terminal device, the online network trading platform issues additional class A tokens equivalent to the deposit to the service provider or the service demander. In contrast, when the service provider or the service demander intends to exchange class A tokens for fiat currency via the first terminal device or the second terminal device, the online network trading platform destroys class A tokens equivalent to the exchange.

In addition, class B tokens are convertible into class A tokens in a 1:1 ratio; and class A tokens are convertible to fiat currency based on an exchange rate (including but not limited to a fixed exchange rate or a variable exchange rate). Fiat currency is convertible to class A tokens.

Furthermore, class A tokens are characterized with at least one of the characteristics including purchasable through fiat currency, transferable to another person, and convertible into fiat currency; yet class B tokens are non-transferable and non-purchasable, the only and unique way to obtain class B tokens is by providing satisfactory services to the type of service provided.

The following examples are given for comprehension to the present invention:

The online network trading platform classifies category A services into six types including food (A1), clothing (A2), housing (A3), transportation (A4), education (A5), and entertainment (A6).

P operates a restaurant on the online network trading platform to serve beef noodle for 100 dollars per bowl. Q ordered the beef noodle and is extremely satisfied, so he gives a score of 10 for evaluation and pays 100 dollars of class A tokens to P and pays additional 10 dollars as evaluation fee (100*10%). As a result, P obtains 100 dollars of class B1 tokens (class B tokens in B1 type) and 100 points of class B1 credits (class B credits in B1 type).

For expenditure, P converts 52.5 dollars of class B1 tokens into class A tokens to consume a taxi service. The service of the taxi driver is just fine but not particularly good, so P evaluates the taxi service with a score of 5 and pays 50 dollars of class A tokens to the taxi driver for the taxi service, and pays additional 2.5 dollars (50*5%) as evaluation fee. In this case, the taxi driver received 25 dollars of class A tokens and 25 dollars of class B4 tokens (class B tokens in B4 type) and 25 points of class B4 credits (class B credits in B4 type).

R is a famous basketball player who provides basketball coaching service, but R only wants to coach someone who provides good services to others, so he requests 40 dollars of any arbitrary types of class B tokens as compensation for his coaching service. P had provided good service to others before and had a balance of 47.5 dollars of class B1 tokens, so R's service is affordable to P. However, the taxi driver only has 25 dollars of class B4 tokens, so R's service is not affordable to the taxi driver.

P admires people who provide education to others and therefore he decides to provide service with a 20% discount for anyone who pays by class B5 tokens. S is a good teacher owning lots of class B5 tokens. S comes to P's restaurant and orders a bowl of beef noodle marked for 100 dollars. Normally, S should pay 100 dollars of class A tokens, but since there is 20% discount for class B5 tokens, S only needs to pay 80 dollars of class B5 tokens for the beef noodle. In this case, P receives 80 dollars of class A tokens.

P hosts a food and beverage seminar desiring to meet others who also operate a restaurant. P may set the registration requirement to be having at least one billion points of class B1 credits (suggesting the person had provided high quality of category A1 service with revenue higher than one billion dollars).

The present invention therefore provides beneficial effects as follows:

1. By the mechanisms of class A tokens and class B tokens according to the present invention, an user on the online network trading platform can be identified by his or her resume, helping others to learn about the user's interaction with the real society.

2. By the mechanisms of tokens according to the present invention, the service provided by the user on the online network trading platform can be identified. The service provider is also allowed to select objects to be served so the service provider could make transactions only with those having particular characteristics or values that the service provider admires.

3. The mechanisms according to the present invention allows “price discrimination” to identical services, motivating the service provider to provide high quality services.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A data processing method of a dual-track token system for exchange of online services, wherein the method is applied to an online network trading platform constructed under a centralized or a distributed data network structure, and the method comprises steps:
(a) the online network trading platform classifying services into at least one category A service and at least one category B service; wherein if a service provider does not select a service demander to be served, proceed to step (b);
(b) the service provider publishing a type of service to be provided as a subordinate of category A services and setting a service price for the type of service to be provided via a first terminal device; wherein the service price is shown on the online network trading platform;
(c) the service demander demanding and purchasing the service by filing a transaction request via a second terminal device; wherein once the online network trading platform successfully matches the service provider with the service demander, the service demander pays for the service price using class A tokens via the second terminal device; and wherein class A tokens are obtained through exchange from fiat currency or valuables on the online network trading platform via the second terminal device;
(d) after completion of the transaction, the service demander evaluating the type of service provided by the service provider with a score via the second terminal device; wherein the online network trading platform performs calculations and depends thereon to determine X number of class A tokens, Y number of class B tokens subordinated to the type of service provided and/or Y points of class B credits subordinated to the type of service provided to be acquired by the service provider; wherein a sum of X number of class A tokens and Y number of class B tokens subordinated to the type of service provided is equivalent to the service price; wherein the higher the score the higher the ratio of class B tokens subordinated to the type of service provided to the service price; and wherein class B credits subordinated to the type of service provided become a part of service resume of the service provider whilst class B tokens subordinated to the type of service provided are permitted for purchasing at least one category B service; and
(e) the service provider selectively converting class B tokens subordinated to the type of service into class A tokens and/or consuming at least one category A service on the online network trading platform via the first terminal device; alternatively, the service provider selectively exchanging class A tokens for fiat currency or valuables on the online network trading platform via the first terminal device.

2. The method according to claim 1, wherein in step (a), if the service provider does select the service demander to be served, proceed to steps:
(b′) the service provider publishing a type of service to be provided as a subordinate of category B services and setting a service price to be paid by at least one type of class B tokens for the type of service to be provided via a first terminal device; wherein the service price in the type of class B tokens required is shown on the online network trading platform;
(c′) the service demander demanding the service and purchasing the service by filing a transaction request via a second terminal device; wherein the online network trading platform examines the transaction request and permits a transaction requester who is capable to pay the service price in the type of class B tokens required by the service provider to be matched; as the online network trading platform successfully matches the service provider and the service demander, the service demander pays for the service price using the required type of class B tokens via the second terminal device; and wherein the required type of class B tokens are obtained by the service demander through the service demander's prior service provisions on the online network trading platform;
(d′) after completion of the transaction, the service provider obtaining at least one type of class A tokens depending on the service price from the online network trading platform via the first terminal device; and
(e′) the service provider consuming at least one category A service using the type of class A tokens on the online network trading platform via the first terminal device; alternatively, the service provider selectively exchanging the type of class A tokens for fiat currency or valuables on the online network trading platform via the first terminal device.

3. The method according to claim 1, wherein in step (c), after the service demander pays the service price using class A tokens via the second terminal device, the service demander obtains credits subordinated to the type of service provided by the service provider as consumer resume of the service demander.

4. The method according to claim 1, wherein in step (d), the online network trading platform charges additional class A tokens as evaluation fee when the service demander evaluates the type of service provided by the service provider via the second terminal device, to ensure fairness of evaluation and prevent the service demander from giving scores that are unreasonably high or low via the second terminal device; and wherein the evaluation fee is depending on the price of class A tokens and the score of evaluation.

5. The method according to claim 3, wherein in step (d), the online network trading platform charges additional class A tokens as evaluation fee when the service demander evaluates the type of service provided by the service provider via the second terminal device, to ensure fairness of evaluation and prevent the service demander from giving scores that are unreasonably high or low via the second terminal device; and wherein the evaluation fee is depending on the price of class A tokens and the score of evaluation.

6. The method according to claim 2, wherein in step (d′), the online network trading platform charges additional the type of class A tokens as evaluation fee when the service demander evaluates the type of service provided by the service provider via the second terminal device, to ensure fairness of evaluation and prevent the service demander from giving scores that are unreasonably high or low via the second terminal device; and wherein the evaluation fee is depending on the price of the type of class A tokens and the score of evaluation.

7. The method according to claim 1, wherein the online network trading platform issues class A tokens based on reserve; when the service provider or the service demander deposits fiat currency to the online network trading platform via the first terminal device or the second terminal device, the online network trading platform issues additional class A tokens equivalent to the deposit to the service provider or the service demander; in contrast, when the service provider or the service demander exchanges class A tokens for fiat currency via the first terminal device or the second terminal device, the online network trading platform destroys class A tokens equivalent to the exchange.

8. The method according to claim 2, wherein the online network trading platform issues class A tokens based on reserve; when the service provider or the service demander deposits fiat currency to the online network trading platform via the first terminal device or the second terminal device, the online network trading platform issues additional class A tokens equivalent to the deposit to the service provider or the service demander; in contrast, when the service provider or the service demander exchanges class A tokens for fiat currency via the first terminal device or the second terminal device, the online network trading platform destroys class A tokens equivalent to the exchange.

9. The method according to claim 1, wherein class B tokens are convertible into class A tokens in a 1:1 ratio, and class A tokens are convertible to fiat currency based on an exchange rate; wherein fiat currency is convertible to class A tokens.

10. The method according to claim 2, wherein class B tokens are convertible into class A tokens in a 1:1 ratio, and class A tokens are convertible to fiat currency based on an exchange rate; wherein fiat currency is convertible to class A tokens.

11. The method according to claim 1, wherein class A tokens are characterized with at least one of the characteristics including purchasable by fiat currency, transferable to another person, and convertible to fiat currency; yet class B tokens are non-transferable and non-purchasable, the only and unique way to obtain class B tokens is by providing satisfactory services to the type of service provided.

12. The method according to claim 2, wherein class A tokens are characterized with at least one of the characteristics including purchasable by fiat currency, transferable to another person, and convertible to fiat currency; yet class B tokens are non-transferable and non-purchasable, the only and unique way to obtain class B tokens is by providing satisfactory services to the type of service provided.
